(19) United States
(12) Patent Application Publication
(10) Pub. No.: US 2013/0316696 A1
(43) Pub. Date: Nov. 28, 2013

(54) Energy Efficient and Accuracy Aware Mobile Services

(71) Applicant: Carnegie Mellon University, Pittsburgh, PA (US)

(72) Inventors: Yun Huang, Jamesville, NY (US); Anthony Slavko Tomasic, Fort Worth, TX (US); Charles Shelby Garrod, Pittsburgh, PA (US)

(73) Assignee: Carnegie Mellon University, Pittsburgh, PA (US)

(21) Appl. No.: 13/902,348

(22) Filed: May 24, 2013

Related U.S. Application Data
(60) Provisional application No. 61/688,983, filed on May 25, 2012.

(51) Int. Cl. H04W 52/02

(52) U.S. Cl. CPC H04W 52/0212
USPC 455/419

(57) ABSTRACT

Systems and methods that can reduce energy resources required by sensors in mobile devices and thereby mitigate premature battery depletion are disclosed. Mobile devices can be assigned groups by a sensor usage management (SUM) server based on the proximity of the mobile devices to one another. Once groups have been established, one or more of the mobile devices within each group can share sensor readings with other mobile devices in its group via the SUM server, such that each mobile device in each group can reduce the overall number of sensor readings that particular device must take. This co-locational “sharing” of representative sensor data among members with groups of co-located mobile devices can reduce overall energy consumption and/or, for a given amount of energy consumption, increase accuracy compared to a situation in which each mobile device in each group exclusively relies on its own sensor data.

### RELATED APPLICATION DATA

This application claims the benefit of priority of U.S. Provisional Application Serial No. 61/688,983, filed on May 25, 2012, and titled “Reducing Sensor Management Energy Cost In Mobile Systems Via Cooperation,” which is incorporated herein by reference in its entirety.

### FIELD OF THE INVENTION

The present invention generally relates to the field of mobile services. In particular, the present invention is directed to energy efficient and accuracy aware mobile services.

### BACKGROUND

Due to the increasing popularity of mobile phones and the proliferation of mobile applications, the use of sensors in mobile devices to report locational data and environmental conditions has become more popular. As is shown in FIG. 1A and well-known in the art, mobile devices, such as mobile devices 100(1) to 100(N), individually connect to one or more mobile-communications networks (here, represented by cloud 104) through various means (represented by the dashed lines in FIG. 1A). Typically, applications installed on a mobile device communicate independently from one another with a service interface within the host mobile device itself in order to, for example, initiate communications, take sensor readings, and manage power settings. Mobile devices have been used with both internal and external sensors for various purposes, an exemplary one of which being updating the geographical location of the devices using GPS sensors. However, sensors in mobile devices often require significant energy resources, which can lead to premature battery depletion.

### SUMMARY OF THE DISCLOSURE

It is understood that the scope of the present invention, as claimed herein, is defined by the scope provided by the independent claims, and it is also understood that the scope of the presently claimed invention is not limited to: (i) the dependent claims, (ii) the detailed description of the non-limiting embodiments, (iii) the summary, (iv) the abstract, and/or (v) description provided outside of this document (that is, outside of the instant application as filed, as prosecuted, and/or as granted).

In one embodiment, the present invention is directed to a method of managing sensor usage among one or more groups of mobile devices using a server, the method comprising receiving, by the server, location updates from each of the mobile devices, grouping, by the server, first ones of the mobile devices into a first co-located group as a function of corresponding respective ones of the location updates, designating, by the server, sensor data from at least one of the first ones of the mobile devices in the first co-located group as being colocation sensor data suitable for use by all of the first ones of the mobile devices in the first co-located group, receiving, by the server, requests for sensor data from the first ones of the mobile devices in the first co-located group, and, in response to said receiving requests for sensor data, pushing, by the server, the colocation sensor data to the first ones of the mobile devices in the first co-located group making the requests.

In another embodiment, the present invention is directed to a method of generating measurements with mobile devices using a server, the method comprising selectively interfacing, by the server, with a first mobile device and a second mobile device, generating, by the server, a measurement indicative of a condition common to both said mobile devices, and transmitting, by the server, the measurement to at least one of the mobile devices.

In a further embodiment, the present invention is directed to a method of generating measurements with mobile devices using a server, comprising receiving, at the server, a first measurement indicative of a condition of a first mobile device generated through the use of a sensor in the first mobile device, receiving, at the server, a second measurement indicative of a condition of a second mobile device generated through the use of a sensor in the second mobile device, analyzing, by the server, the first and second measurements, and determining, by the server, whether the first and the second mobile devices should be treated as a group based on the analysis of the first and second measurements, and, if the determination of whether the first and second mobile devices should be treated as a group is positive, defining a first group comprising the first mobile device and second mobile device, receiving, at the server, a third measurement indicative of a condition of the first mobile device generated through the use of the sensor in the first mobile device, and transmitting, by the server, said third measurement or data derived at least partially from said third measurement to the second mobile device.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1A is a diagram of an exemplary conventional mobile device network;

FIG. 1B is a diagram of an energy efficient and accuracy aware (E2A2) illustrating exemplary groupings of mobile devices using a sensor usage management (SUM) server made in accordance with the present disclosure;

FIG. 2 is a diagram of an E2A2 system made in accordance with an embodiment of the present invention, showing exemplary aspects of the SUM server abstracted by functionality;

FIG. 3 is a flow diagram of a group assignment and group location update method according to an embodiment of the present invention;

FIG. 4 is a flow diagram of a location request processing method according to an embodiment of the present invention;

FIG. 5 is a diagram of a colocation scenario illustrating exemplary methods of the invention;

FIG. 6A is a block diagram illustrating an exemplary data flow for a mobile device made in accordance with the present disclosure;

FIG. 6B is a block diagram illustrating an alternative data flow for a mobile device made in accordance with the present disclosure;

FIG. 6C is a block diagram illustrating an exemplary network data flow of an E2A2 system made in accordance with an embodiment of the present invention; and

FIG. 7 is a is a high-level diagram of a computing system that can be used to contain and execute software instructions for implementing one or more of the functionalities described herein.

It is noted that the drawings are not necessarily to scale and that various embodiments may be illustrated by phantom lines, diagrammatic representations, and/or fragmentary views. In certain instances, details that are not necessary for an understanding of the embodiments or that render other details difficult to perceive may have been omitted.

### DETAILED DESCRIPTION

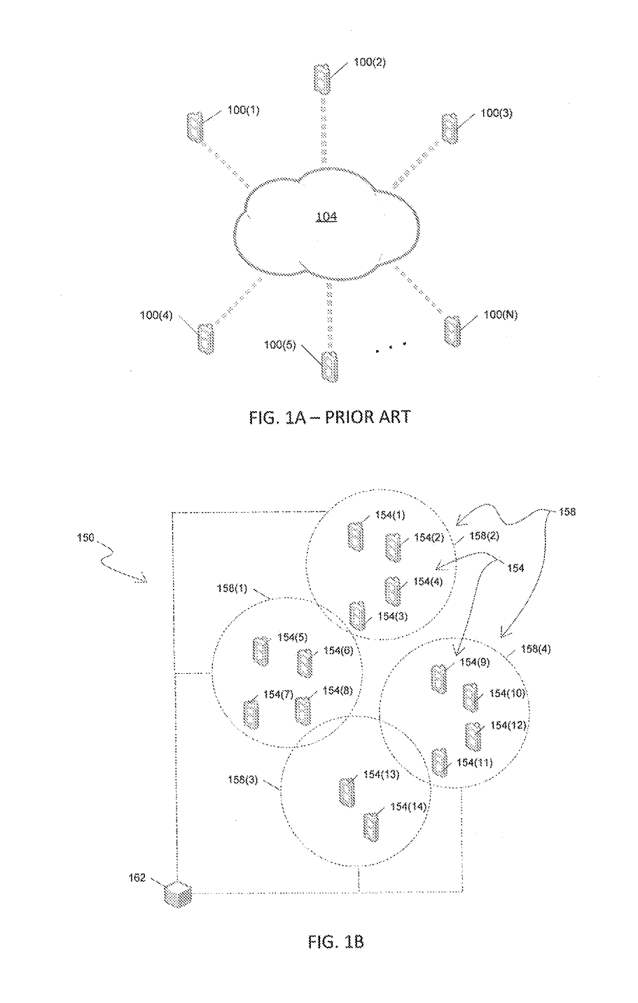

Energy efficient and accuracy aware (E2A2) mobile services according to the present invention can reduce energy resources required by sensors in mobile devices and thereby mitigate premature battery depletion. As shown in FIG. 1B, in contrast to the exclusively individual operation of the prior art mobile devices shown in FIG. 1A, in an exemplary E2A2 system 150 according to the present invention, mobile devices 154, here fourteen mobile devices 154(1) to 154(14), can be assigned groups 158, here four groups 158(1) to 158(4), by a sensor usage management (SUM) server 162 as a function of the proximity of the mobile devices 150 to one another. Once groups 158 have been established, one or more of the mobile devices 154 within each group can effectively share sensor readings with other mobile devices in its/their group via SUM server 162, such that each mobile device in each group can reduce the overall number of sensor readings that particular device must take. This is so, especially in cases in which the energy costs of each mobile device 154 communicating with SUM server 162 are less than the costs of obtaining a reading from that device's own sensor. This co-locational “sharing” of representative sensor data among members with groups of co-located mobile devices, such as mobile devices 154 of groups 158, can reduce overall energy consumption of mobile devices and/or, for a given amount of energy consumption, increase accuracy compared to a situation in which each mobile device in each group exclusively relies on its own sensor data. It is noted that while FIG. 1B illustrates SUM server 162 as being graphically distinct from mobile devices 154, in fact a SUM server made in accordance with the present invention can take any of a variety of forms. For example, the SUM server can be a central server (e.g., an enterprise server or server at a server farm, or a group of such servers), a personal computer (e.g., laptop, desktop), or a mobile device (e.g., a smartphone, tablet computing device, etc.). Fundamentally, there is no limitation as to the form of a SUM server of the present invention.

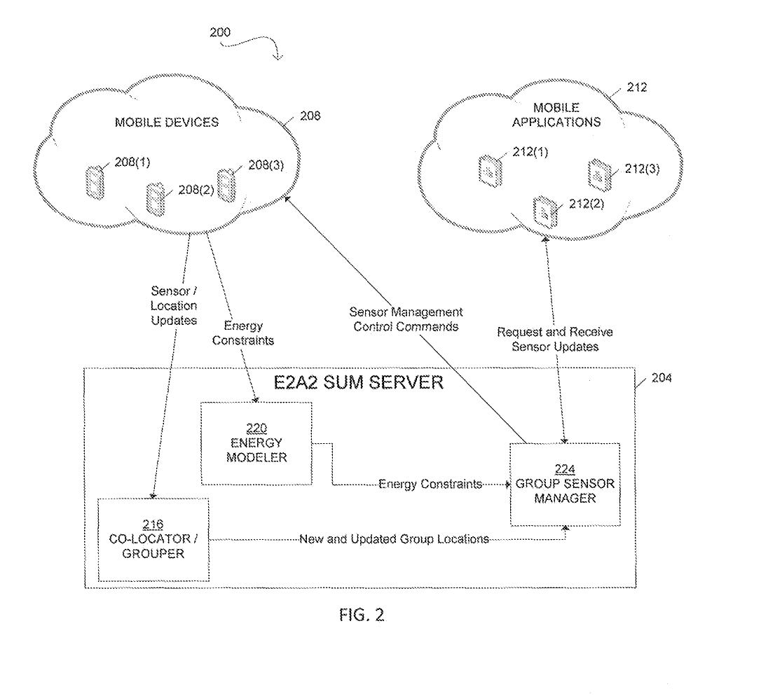

Referring now to FIG. 2, this figure illustrates an E2A2 system 200 of the present disclosure from a functionality perspective. As those skilled in the art will readily appreciate, E2A2 system 200 can be used, for example, as E2A2 system 150 of FIG. 1B. As seen in FIG. 2, E2A2 system 200 includes a SUM server 204, mobile devices 208, here three mobile devices 208(1) to 208(3), and mobile applications 212 running on those mobile devices 208, in this example three mobile applications 212(1) to 212(3) running on mobile devices 208(1) to 208(3), respectively. In the embodiment illustrated, SUM server 204 includes a co-locator/grouper 216, an energy modeler 220, and a group sensor manager 224. That said, it should be appreciated that in other embodiments a SUM server need not necessarily include all three of these functionalities. For example, some embodiments may not include an energy modeler. Those skilled in the art will understand the functional variations that can be incorporated into a SUM server of the present disclosure after reading this entire disclosure.

As shown in FIG. 2, mobile devices 208 can send location/sensor updates and energy constraints to co-locator/grouper 216 and energy modeler 220, respectively, of the SUM server 204. Co-locator/grouper 216 determines which of mobile devices 208 to group together and forwards those groups, their locations, and other group-specific sensor data (if any) to group sensor manager 224. Energy modeler 220 processes energy constraints, if necessary, and forwards energy constraints to group sensor manager 224. Group sensor manager 224 makes a final determination as to which mobile devices, such as mobile devices 208, to group based on the information received from co-locator/grouper 216 and energy modeler 220, and, based on that determination, provides data to requesting ones of mobile applications 212 and sends sensor management control commands, such as requests for new location or sensor data, from mobile devices 208 when necessary (after a specified timing threshold, for example, as described further below).

Mobile devices 208 can provide location and other sensor data, if any, to co-locator/grouper 216 in the form of GPS coordinates, digital readings, and any other suitable data types. Other sensor data provided may be from any one or more sensors that are located onboard and/or external to mobile devices 108. Mobile devices 208 may provide energy constraints to energy modeler 220 in the form of an energy profile selection selected from plural predetermined energy profiles or in the form of explicit values for thresholds, error tolerances, and other settings. Predetermined energy profiles can include options such as, for example, a low-accuracy-low-energy profile, a high-accuracy-high-energy profile, a balanced-accuracy-and-energy profile, or any other suitable energy profiles.

Energy modeler 220 may translate energy constraints received in the form of energy profiles into predetermined thresholds, error tolerances, and/or other settings (described further below) that correspond to selected profiles. For example, if a mobile device transmits data corresponding to a high-accuracy-high-energy profile, energy modeler 220 can translate that profile into thresholds, error tolerances, and/or other settings that correspond to that profile and transmit those preferences to group sensor manager 224.

For example, devices 208 may be in close enough proximity that co-locator/grouper 216 would consider them to comprise a single group. If none of devices 208 transmit any energy constraints, group sensor manager 224 may consider them a single group and deal with them accordingly (for example, by facilitating data-sharing between the mobile applications 212 running on the devices 208). However, for example, if one of devices 208, for example device 208(1), transmits data corresponding to a high-accuracy-high-energy profile to energy modeler 220, the energy modeler may forward settings corresponding to that profile to group sensor manager 224, and the group sensor manager will implement those settings for the mobile device that transmitted them. This can result in group sensor manager 224 not grouping mobile device 208(1) with mobile devices 208(2) and 208(3) despite the fact that it would have in the absence of mobile device 208(1) transmitting the high-accuracy-high-energy profile. This could happen when one mobile device requires a lower error tolerance (i.e., higher precision) than other mobile devices in its proximity. In this situation, location and/or sensor data from mobile device 208(1), or data derived therefrom, may be transmitted to mobile applications 212(2) and 212(3) since mobile device 208(1) is located within the acceptable (or default) error tolerances of mobile devices 208(2) and 208(3); however, similar data from devices 208(2) and 208(3) will not be transmitted to mobile application 212(1) as long as the group location of devices 208(2) and 208(3) (which could be, for example, the average position of devices 208(2) and 208(3)) is outside of the acceptable error tolerance generated by energy modeler 220 in response to the energy profile data sent by device 208(1)). In this way, mobile applications 212 can request and receive group sensor updates while group sensor manager 224 verifies groupings and requests sensor updates from mobile devices 208 as necessary.

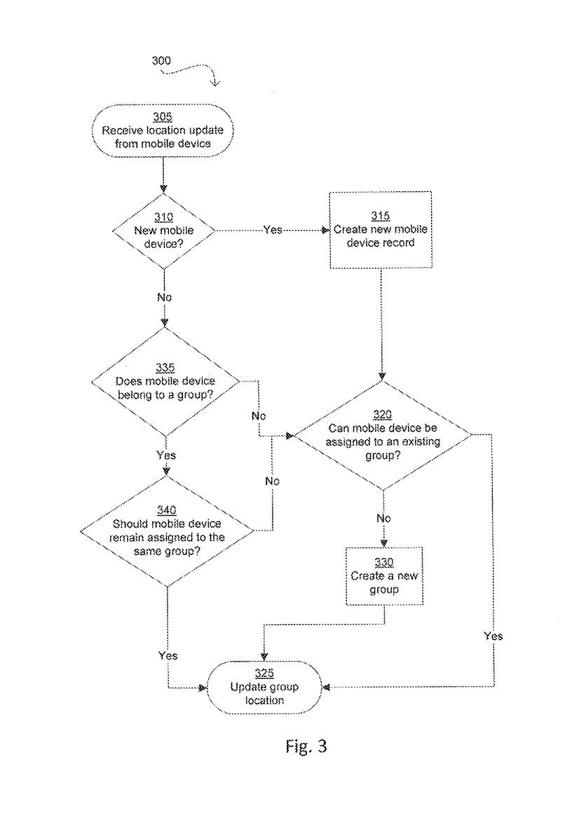

FIG. 3 illustrates an exemplary method 300 of updating group assignment and group location that can be performed by a co-locator/grouper of a SUM server of the present disclosure, such as co-locator/grouper 216 of SUM server 204 of FIG. 2. At step 305 the SUM server receives location information from a mobile device, and, at step 310 the server determines whether the mobile device has previously communicated with the server. If the mobile device has not previously communicated with the server, at step 315 the SUM server creates a new mobile device record and, at step 320 determines whether the mobile device can be assigned to an existing group. The determination as to whether the mobile device can be assigned to an existing group can be based, for example, on the group timing threshold and a comparison between a group location and the location information received from the mobile device at step 305. If the group timing threshold has elapsed since the last group location update for any given group, that group is no longer considered to exist; however, if the group timing threshold has not elapsed since the last group location update for a given group, that group's location is compared to the location information received from the mobile device at step 305. If the difference between the location information received at step 305 and the group location is less than a predetermined group radius and, if applicable, less than a predetermined error tolerance, the mobile device is assigned to that group; otherwise a new group is created for the mobile device at step 330 as described above.

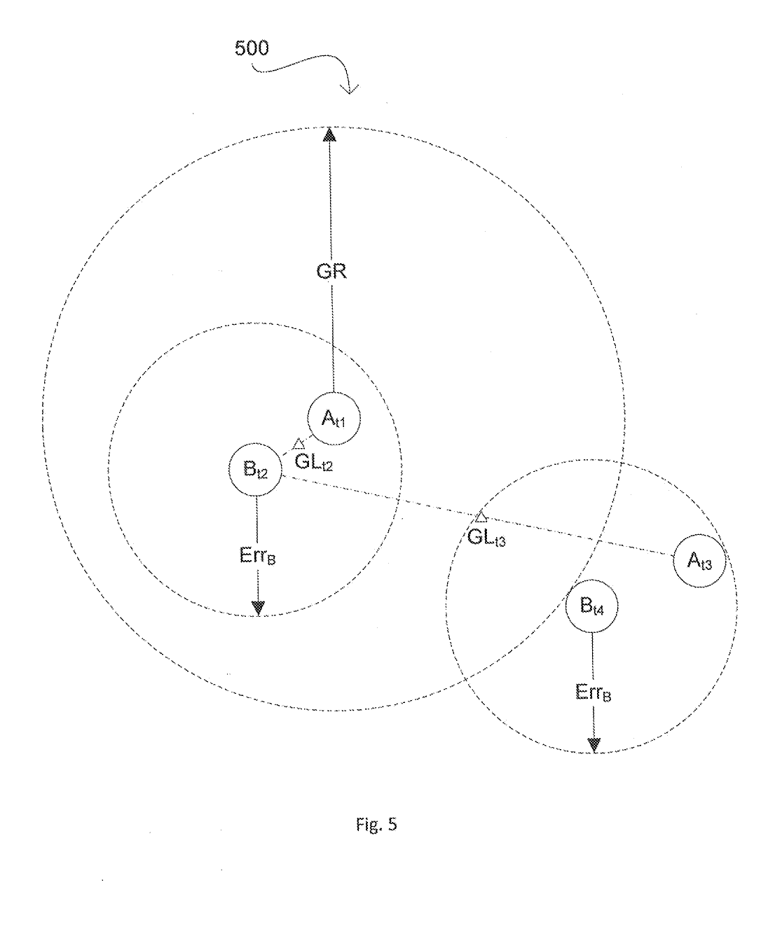

If the mobile device can be assigned to an existing group, the SUM server assigns it to the appropriate group and, at step 325 sets that group's location based on the location update received at step 305. The group location can be updated through any of several suitable methods. For example, in an exemplary embodiment, the group location can be updated by averaging all of the most recent location information received from all of the established members of the group and setting the result as the new group location (an example of this is described below with reference to FIG. 5). Alternatively, the group location can be updated by setting the most recent location information received from any one of the established members of the group as the new group location. Another alternative is to average the group location with the most recent location information received from any one of the established members of the group and setting the result as the new group location. The group location can also be based on some combination of historical patterns of usage, energy profile information, and recent information; a statistical and/or heuristic model can be used to derive group locations or to predict future group locations from this information. Given these examples, one of ordinary skill in the art will realize that there are many other group location updating methods that would be obvious to use in view of the description and figures provided in the instant disclosure and that, as a result, are all within the scope of the present invention.

If the mobile device cannot be assigned to an existing group, then, at step 330, the SUM server creates a new group for it and, at step 325, sets the new group's location based on the location update received at step 305. If the mobile device has previously communicated with the server, the method proceeds from step 310 to step 335, at which time the SUM server determines whether the mobile device belongs to an existing group. The determination as to whether the mobile device belongs to an existing group can be based on a comparison between a group timing threshold and the amount of time that has passed between the time the server received the location information from the mobile device at step 305 and the last time before that that the server received location information from the mobile device (if applicable). If the amount of time that has passed between the time the server received the location information from the mobile device at step 305 and the last time before that that the server received location information from the mobile device is greater than the group timing threshold, or if the server has not received location information from the mobile device before the time the server received the location information from the mobile device at step 305, the mobile device is no longer considered a member of an existing group; if that amount of time is less than the group timing threshold, the mobile device is considered to remain a member of the group to which it was previously assigned.

If the mobile device does not belong to an existing group, the method proceeds to step 320 and proceeds as described above. On the other hand, if the mobile device does belong to an existing group, at step 340 the SUM server determines whether the mobile device should remain assigned to the same group. The determination as to whether the mobile device should remain assigned to the same group is similar to step 320 described above. As above, this determination can be based on the group timing threshold and a comparison between a group location and the location information received from the mobile device at step 305. As noted above, if the group timing threshold has elapsed since the last group location update for any given group, that group is no longer considered to exist; however, if the group timing threshold has not elapsed since the last group location update for a group to which the mobile device has previously been assigned, that group's location is compared to the location information received from the mobile device at step 305. If the difference between the location information received at step 305 and the group location is less than a predetermined group radius and, if applicable, less than a predetermined error tolerance, the mobile device is considered to remain in that group and method 300 proceeds to step 325 at which the SUM server sets the group's location based on the located update received at step 305; otherwise the method proceeds to step 320 and continues as described above.

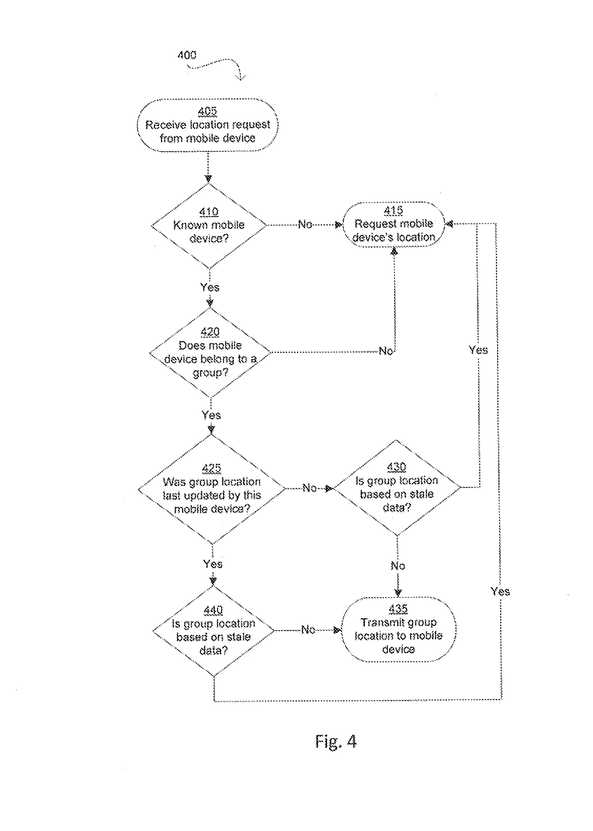

FIG. 4 illustrates an exemplary method 400 of location request processing that can be performed by an energy modeler of a SUM server of the present disclosure, such as energy modeler 220 of SUM server 204 of FIG. 2. At step 405, the SUM server receives a location request from a mobile device, and, at step 410, the server determines whether the mobile device has previously communicated with the server. If the mobile device has not previously communicated with the server, at step 415 the SUM server requests a location sensor reading from the mobile device; if the mobile device has previously communicated with the server, the method proceeds to step 420, at which time the SUM server makes a determination as to whether the mobile device belongs to an existing group (which, for example, can be performed in substantially the same way as step 335 of FIG. 3).

If the mobile device does not belong to an existing group, at step 415 the SUM server requests a location sensor reading from the mobile device; if the mobile device does belong to an existing group, the method proceeds to step 425 at which time to the SUM server determines whether the group location was last updated by the mobile device which transmitted the location request (received at step 405). If the group location was not last updated by the mobile device that transmitted the location request received at step 405, the method proceeds to step 430, at which time the SUM server determines whether the group location is based on stale data. The determination in step 430 as to whether the group location last updated by a different mobile device (than the one which requested a location in step 405) is based on stale data can involve comparing the time at which the server received the location request from the mobile device (at step 405) to the time the group location was last updated by the other mobile device. If the difference between these two times is greater than a first timing threshold, the group location is considered to be stale.

If the determination at step 430 is positive, the SUM server requests a location sensor reading from the mobile device at step 415; if the determination is negative, the server transmits the last known group location to the mobile device at step 435.

If the determination in step 425 as to whether the group location was last updated by the mobile device which transmitted the location request is positive, at step 440 the SUM server determines whether the group location is based on stale data. The determination in step 440 as to whether the group location last updated by the mobile device which requested a location in step 405 is based on stale data can involve comparing the time at which the server received the location request from the mobile device (at step 405) to the time the group location was last updated by the mobile device. If the difference between these two times is greater than a second timing threshold, the group location is considered to be stale. If the determination at step 440 is positive, the server requests a location sensor reading from the mobile device at step 415; if the determination is negative, the server transmits the last known group location to the mobile device at step 435.

In an exemplary embodiment, once the server has requested a location sensor reading from the mobile device at step 415, the mobile device takes a new sensor reading and transmits the new reading to the server. Alternatively, the mobile device may determine whether a new reading should be taken based on, for example, any one or more of historical patterns of usage, energy profile information, and recent information; a statistical and/or heuristic model may be used. For example, if the mobile device is consuming more energy on average than an energy profile associated with that mobile device permits, the mobile device may simply refuse to respond to the server's request for a new sensor reading. Alternatively, the mobile device may transmit its last known location (without taking a new sensor reading) along with a low-power indicator; the low-power indicator, which could be, for example, a bit, a bit stream, or metadata, can indicate to the server that the mobile device that transmitted it should be associated with a lower power energy profile. If the server determines that a mobile device is or should be associated with a lower-power energy profile, it may limit the number of requests for new sensor readings that it transmits to that device. In some situations, if the mobile device or server has determined that acquiring new sensor data from a given sensor would require too much energy, alternative, less-accurate sensors may be employed (for example, if a GPS reading would use too much energy, Wi-Fi or cellular proximity could be sensed instead).

The timing thresholds, error tolerance, and group radius can be set to accommodate desired applications and desired accuracy/battery life. The first and second timing thresholds and error tolerance can be set to larger values to extend battery life at the expense of accuracy or, alternatively, smaller values to increase accuracy at the expense of shortened battery life. The first and second timing thresholds and error tolerance can be set numerically or chosen from a list of predetermined options by a user of one of the mobile devices (and communicated to the server). Alternatively, the first and second timing thresholds and error tolerance can be set numerically or chosen from a list of predetermined options by a server administrator. The first and second timing thresholds and error tolerance can be adjusted by the mobile devices (based on user preference) or the server (based on administrator preference) in real-time based on an algorithm or based on a predetermined schedule. In an exemplary embodiment, the first timing threshold is shorter than the second timing threshold.

The group timing threshold and the group radius can be set numerically or chosen from a list of predetermined options by a server administrator. The group timing threshold and the group radius can be adjusted by the server (based on administrator preference) in real-time based on an algorithm or based on a predetermined schedule. In an exemplary embodiment, the group timing threshold is longer than the first timing threshold and the second timing threshold. Given these examples, one of ordinary skill in the art will realize that there are many possible combinations of settings for the timing thresholds and group radius that would be obvious to use in view of the description and figures provided in the instant disclosure and that, as a result, are all within the scope of the present invention.

Turning now to an exemplary colocation scenario 500, shown in FIG. 5, in order to illustrate exemplary aspects of the invention, two mobile devices A and B are represented by small circles. Subscripts t1, t2, t3, and t4 represent respective times at which location information is received from mobile devices A and B where t1<t2<t3<t4 and the difference between any sequential two of t1, t2, t3, and t4 is smaller than any of the first, second, or group timing thresholds. GR represents the group radius, GL represents the group location at a respective time, and Err_{B} represents mobile device B's error tolerance. In this scenario, mobile device A transmits its location at time t1. A new group is created at step 330 of method 300 of FIG. 3 having group radius GR and its group location is set to be centered on A at step 325. Mobile device B transmits its location at time t2; because the location B transmitted (Bₜ₂) is within GR and Err_{B} of the group location (Aₜ₁), mobile device B is assigned to mobile device A's group at step 320 of method 300. At that time (t2) the group location is updated, at step 325 of method 300, to GLₜ₂. When mobile device A sends another update at time t3, the group location is updated to GLₜ₃ at step 325 of method 300. When mobile device B requests a location update (but does not send any location information) at time t4, the group location GLₜ₃ is transmitted to mobile device B at step 435 of method 400.

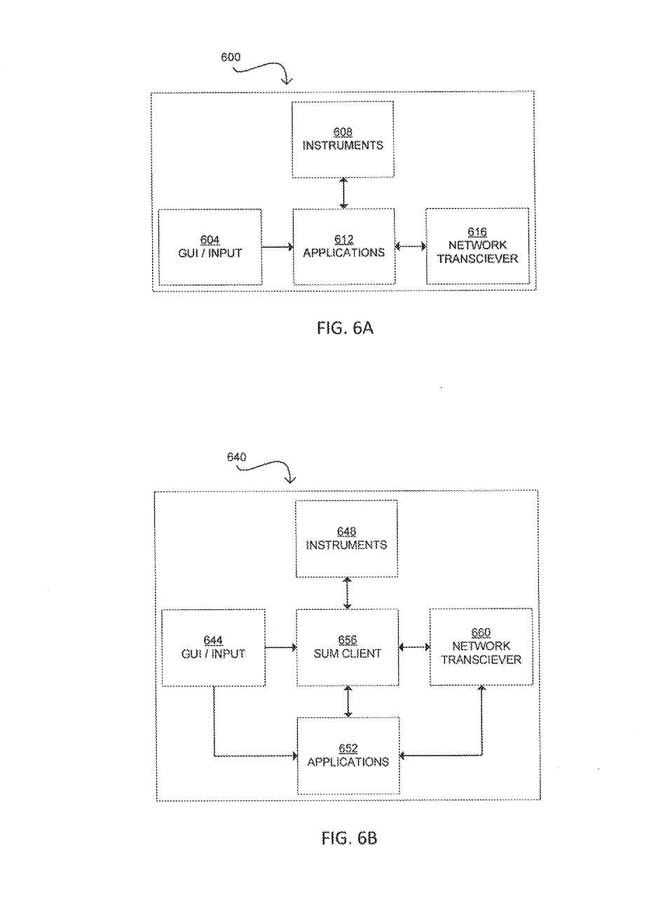

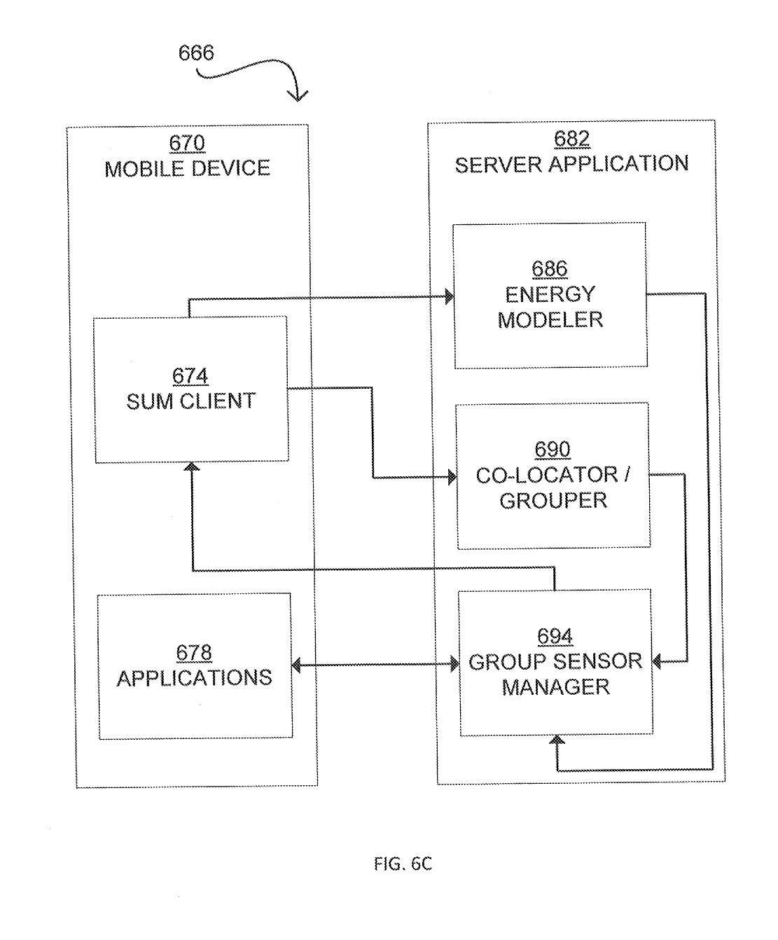

FIGS. 6A-6C illustrate exemplary dataflow models within a mobile device (FIGS. 6A and 6B) and between a SUM server and a mobile device (FIG. 6C) according to exemplary embodiments of the invention. Referring first to FIG. 6A, this depicts a first exemplary dataflow within a mobile device 600 of the present disclosure, such as mobile device 154(1) of FIG. 1B, in which the dataflow stems from the direct handing of communications with a SUM server (not shown) by each of one or more mobile applications 612 aboard the mobile device that require sensor data. Fundamentally, there is no limit on the nature of an application that can be used for application(s) 612 other than it requires sensor date relating to one or more conditions of mobile device 600 and/or one or more conditions able to be sensed by the device via one or more internal instruments 608 and/or one or more external instruments (not shown). A user of mobile device 600 can provide input to any one or more of applications 612 or other features of the mobile device through a suitable GUI/input device 604. Each application 612 operatively interfaces with one or more instrument(s) 608 in any suitable manner, such as through one or more appropriate system-level or other interfaces (not shown) integrated into or with mobile device 600.

A network transceiver 616 is provided to allow mobile device 600, for example, the one or more applications 612, to communicate with a SUM server to transmit and receive updated instrument and/or sensor data according to aspects of the invention, such as aspects described above. Those skilled in the art will readily appreciate that mobile device 600, like any of the mobile devices described herein can be any suitable mobile device carried by a user. Examples of mobile devices that mobile device 600 can be include, but are not limited to mobile computing device, including smartphones, tablets, laptops, and mobile computing devices of other form factors, cell phones, cameras, personal and vehicle-based navigation devices, personal digital assistants, and mobile data loggers, among others. Fundamentally, there is no limit to the type and/or form factor of a mobile device that can be used with aspects of the present invention other than that the device runs software that requires one or more types of sensor data relating to one or more conditions of and/or one or more conditions surrounding the device and that the device is capable of acquiring sensor date from one or more internal sensors/instruments and/or external sensors/instruments.

FIG. 6B depicts an alternative dataflow within a mobile device 640 of the present disclosure, such as mobile device 154(1) of FIG. 1B. In this example, the dataflow is different from the dataflow of FIG. 6A due to the mobile device 640 running a SUM client 656 that interfaces between one or more mobile applications 652 and a SUM server (not shown). As with mobile applications 612 of FIG. 6A, each mobile application 652 of FIG. B can be an application that requires sensor data to provide the user with certain functionality. However, in the case of mobile applications 652, each application can be a mobile application that is not particularly configured to interact with a SUM server. Fundamentally, there is no limit on the nature of an application that can be used for application(s) 652 other than it requires sensor data relating to one or more conditions of mobile device 640 and/or one or more conditions able to be sensed by the device via one or more internal instruments 648 and/or one or more external instruments (not shown).

As seen in FIG. 6B, mobile device 640 can further include, among other things, a GUI and input device 644 and a network transceiver 660. In the dataflow of FIG. 6B, SUM client 656 also provides an interface between instruments/sensors 648 and mobile applications 652. Each time any of mobile applications 652 attempt to utilize one of instruments/sensors 648, SUM client 656 interfaces with a SUM server via network transceiver 660 in order to attempt to retrieve group instrument/sensor data that can be used instead of taking a reading or measurement from onboard instruments/sensors 648. If group instrument/sensor data is not available, SUM client 656 enables the appropriate instrument/sensor 648 and takes a measurement/reading therefrom. If desired and depending on the nature of application(s) 652, SUM client 656 can be disabled; this would result in the dataflow model of FIG. 6B reverting to the dataflow model shown in FIG. 6A that allows applications 652 to directly interface with instruments/sensors 648.

As stated above, if group instrument/sensor data is not available, SUM client 656 enables the appropriate instrument/sensor 648 and takes a measurement/reading therefrom. However, rather than simply taking a new reading, SUM client 656 may determine whether a new reading should be taken based on, for example, any one or more of historical patterns of usage, energy profile information, and recent information; a statistical and/or heuristic model may be used. For example, if mobile device 640 is consuming more energy on average than an energy profile associated with that mobile device permits, SUM client 656 may simply not respond to a mobile application's request for a new sensor reading. Alternatively, SUM client 656 may transmit a previously-acquired sensor reading (without taking a new sensor reading) along with a low-power indicator to the requesting mobile application; the low-power indicator, which could be, for example, a bit, a bit stream, or metadata, can indicate to the application that SUM client 656 has determined that a lower-power energy profile should be implemented and that the sensor data transmitted therewith is based on a previously-acquired sensor reading. If the SUM client determines that a mobile device is or should be associated with a lower power energy profile, it may limit the number of new sensor readings that it executes. In some situations, if the SUM client has determined that acquiring new sensor data from a given sensor would require too much energy, alternative, less-accurate sensors may be employed (for example, if a GPS reading would use too much energy, Wi-Fi or cellular proximity could be sensed instead).

FIG. 6C depicts a model 666 that represents the flow of data within an overall E2A2 system, such as the E2A2 system 150 of FIG. 1B, from the perspective of a single mobile device 670, which can be any of the mobile devices of the present disclosure, such as mobile device 154(1) of FIG. 1B. As seen in FIG. 6C, mobile device 670 can include, among other things, a SUM client 674 and applications 678 (e.g., in the manner of mobile device 640 of FIG. 6B), which communicate with a SUM server 682. In this example, SUM server 682 includes, in the manner of SUM server 204 of FIG. 2, an energy modeler 686, a co-locator/grouper 690, and a group sensor manager 694. In this embodiment and as represented by arrows connecting the various blocks of FIG. 6C, SUM client 274 transmits location/sensor updates and, optionally, energy constraints to co-locator/grouper 690 and energy modeler 686, respectively, of the SUM server 682. Co-locator/grouper 690 determines whether to group mobile device 670 with other mobile devices and forwards those groups, their locations, and other group-specific sensor data (if any) to group sensor manager 694. Energy modeler 686 processes energy constraints, if necessary, and forwards energy constraints to group sensor manager 694. Group sensor manager 224 makes a final determination as to which mobile devices to group based on the information received from co-locator/grouper 690 and energy modeler 686, and, based on that determination, provides data to mobile applications 678 and sends sensor management control commands, such as requests for new location or sensor data, from the SUM client 674 when necessary (i.e., when group data has become stale).

In an exemplary embodiment, group sensor manager 224 may determine whether a new reading should be requested based on, for example, any one or more of historical patterns of usage, energy profile information, and recent information; a statistical and/or heuristic model may be used. For example, if a mobile device is consuming more energy on average than an energy profile associated with that mobile device permits, group sensor manager 224 may cease or limit requests of new sensor readings from that device. In some situations, if group sensor manager 224 has determined that requesting new sensor data from a given mobile device would require too much energy consumption for that particular mobile device, it may request new sensor data from that device derived from alternative, less accurate sensors (for example, if a GPS reading would use too much energy, Wi-Fi or cellular proximity sensor readings could be requested instead) or simply limit its requests for new sensor data to other mobile devices in the same group. Group sensor manager 224 may determine which mobile device in a given group to interrogate for new sensor data based on, for example, any one or more of historical patterns of usage, energy profile information, and recent information; a statistical and/or heuristic model may be used.

Though applications 678 are shown in FIG. 6C as interfacing directly with group sensor manager 694, it is understood that this is an exemplary representation of data flow and that, as shown in FIGS. 6A-B and described above, applications 678 can interface with the SUM server via SUM client 656 if desired.

An exemplary mobile device that can be used in an E2A2 system made in accordance with the present disclosure, such as E2A2 system 150 of FIG. 1B, can include a memory containing one or more applications, such as applications 612 shown in FIG. 6A, and various instruments and/or sensors, such as instruments 608 shown in FIG. 6A, that can be utilized by the applications. Applications that can be used with a mobile device according to the invention can include, for example, a SUM client as described above, such as SUM client 656 shown in FIG. 6B, Tiramisu (a real-time bus tracker application, see U.S. patent application Ser. No. 13/639,995 of Tomasic et al., filed on Apr. 8, 2011, and titled “CROWD-SOURCING OF INFORMATION FOR SHARED TRANSPORTATION VEHICLES”, which is incorporated herein for its disclosure of scenarios utilizing crowd-sourced data), a CO₂-monitoring application, a dust-monitoring or pollen-monitoring application, a humidity-monitoring application, and an audio-monitoring application, among others. Instruments/sensors that can be attached to mobile devices can include, but not necessarily be limited to, a GPS sensor/transceiver, a CO₂ sensor, a dust or pollen-count sensor, a humidity sensor, a microphone or other audio sensor, and a video or still camera/sensor. Other elements that can be included in a mobile device according to the present disclosure include a display, graphical user interface (GUI)/input devices, one or more processors (which run the one or more applications), a local network transceiver (for example, a BLUETOOTH transceiver), and a remote network transceiver (for example, a cellular transceiver), among others, as further described below.

An exemplary server according to the invention can include a memory containing one or more server applications which can include, for example, co-locator/grouper 216, energy modeler 220, and group sensor manager 224, as shown in FIG. 2. Other elements that can be included in a server according to the invention include one or more processors (which run the one or more server applications), a local network transceiver (for example, a BLUETOOTH transceiver), and a remote network transceiver (for example, a cellular transceiver), among others, as further described below.

It is to be noted that any one or more of the aspects and embodiments described herein may be conveniently implemented using one or more machines (e.g., one or more computing devices that are utilized as a user computing device for an electronic document, one or more server devices, such as a document server) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations described above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk (e.g., a conventional floppy disk, a hard drive disk), an optical disk (e.g., a compact disk “CD”, such as a readable, writable, and/or re-writable CD; a digital video disk “DVD”, such as a readable, writable, and/or rewritable DVD), a magneto-optical disk, a read-only memory “ROM” device, a random access memory “RAM” device, a magnetic card, an optical card, a solid-state memory device (e.g., a flash memory), an EPROM, an EEPROM, and any combinations thereof. A machine-readable medium, as used herein, is intended to include a single medium as well as a collection of physically separate media, such as, for example, a collection of compact disks or one or more hard disk drives in combination with a computer memory. As used herein, a machine-readable storage medium does not include a signal.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

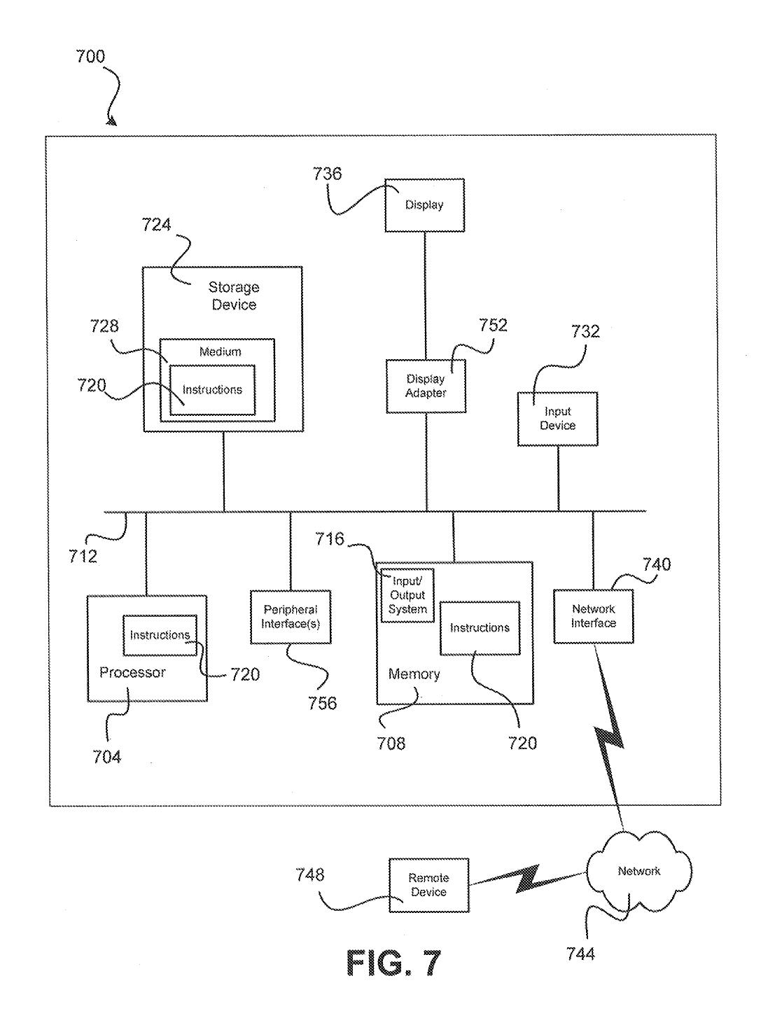

FIG. 7 shows a diagrammatic representation of one embodiment of a computing device in the exemplary form of a computer system 700 within which a set of instructions for causing the computer system to perform any one or more of the aspects and/or methodologies of the present disclosure. It is also contemplated that multiple computing devices may be utilized to implement a specially configured set of instructions for causing the devices to perform any one or more of the aspects and/or methodologies of the present disclosure. Computer system 700 includes a processor 704 and a memory 708 that communicate with each other, and with other components, via a bus 712. Bus 712 may include any of several types of bus structures including, but not limited to, a memory bus, a memory controller, a peripheral bus, a local bus, and any combinations thereof, using any of a variety of bus architectures.

Memory 708 may include various components (e.g., machine readable media) including, but not limited to, a random access memory component (e.g., a static RAM “SRAM”, a dynamic RAM “DRAM”, etc.), a read only component, and any combinations thereof. In one example, a basic input/output system 716 (BIOS), including basic routines that help to transfer information between elements within computer system 700, such as during start-up, may be stored in memory 708. Memory 708 may also include (e.g., stored on one or more machine-readable media) instructions (e.g., software) 720 embodying any one or more of the aspects and/or methodologies of the present disclosure. In another example, memory 708 may further include any number of program modules including, but not limited to, an operating system, one or more application programs, other program modules, program data, and any combinations thereof.

Computer system 700 may also include a storage device 724. Examples of a storage device (e.g., storage device 724) include, but are not limited to, a hard disk drive for reading from and/or writing to a hard disk, a magnetic disk drive for reading from and/or writing to a removable magnetic disk, an optical disk drive for reading from and/or writing to an optical medium (e.g., a CD, a DVD, etc.), a solid-state memory device, and any combinations thereof. Storage device 724 may be connected to bus 712 by an appropriate interface (not shown). Example interfaces include, but are not limited to, SCSI, advanced technology attachment (ATA), serial ATA, universal serial bus (USB), IEEE 1294 (FIREWIRE), and any combinations thereof. In one example, storage device 724 (or one or more components thereof) may be removably interfaced with computer system 700 (e.g., via an external port connector (not shown)). Particularly, storage device 724 and an associated machine-readable storage medium 728 may provide nonvolatile and/or volatile storage of machine-readable instructions, data structures, program modules, and/or other data for computer system 700. In one example, software 720 may reside, completely or partially, within machine-readable storage medium 728. In another example, software 720 may reside, completely or partially, within processor 704.

Computer system 700 may also include an input device 732. In one example, a user of computer system 700 may enter commands and/or other information into computer system 700 via input device 732. Examples of an input device 732 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), touchscreen, and any combinations thereof. Input device 732 may be interfaced to bus 712 via any of a variety of interfaces (not shown) including, but not limited to, a serial interface, a parallel interface, a game port, a USB interface, a FIREWIRE interface, a direct interface to bus 712, and any combinations thereof. Input device 732 may include a touch screen interface that may be a part of or separate from display 736, described further below. Input device 732 may be utilized as a user selection device for selecting one or more graphical representations in a graphical interface as described above.

A user may also input commands and/or other information to computer system 700 via storage device 724 (e.g., a removable disk drive, a flash drive, etc.) and/or network interface device 740. A network interface device, such as network interface device 740 may be utilized for connecting computer system 700 to one or more of a variety of networks, such as network 744, and one or more remote devices 748 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 744, may employ a wired and/or a wireless mode of communication. In general, any network topology may be used. Information (e.g., data, software 720, etc.) may be communicated to and/or from computer system 700 via network interface device 740.

Computer system 700 may further include a video display adapter 752 for communicating a displayable image to a display device, such as display device 736. Examples of a display device include, but are not limited to, a liquid crystal display (LCD), a cathode ray tube (CRT), a plasma display, a light emitting diode (LED) display, and any combinations thereof. Display adapter 752 and display device 736 may be utilized in combination with processor 704 to provide a graphical representation of a utility resource, a location of a land parcel, and/or a location of an easement to a user. In addition to a display device, a computer system 700 may include one or more other peripheral output devices including, but not limited to, an audio speaker, a printer, and any combinations thereof. Such peripheral output devices may be connected to bus 712 via a peripheral interface 756. Examples of a peripheral interface include, but are not limited to, a serial port, a USB connection, a FIREWIRE connection, a parallel connection, and any combinations thereof.

Alternative exemplary embodiments are described in the following paragraphs. It is noted that while each of these embodiments is expressed in the form of methods, it should be understood that these methods and any of the other methods disclosed herein can be embodied in sets of machine-executable instructions that can be stored on one or more machine-readable storage media and executed by one or more machines configured to execute such instructions.

In an alternative exemplary embodiment, a method of managing sensor usage among one or more groups of mobile devices using a sensor usage management (SUM) server comprises receiving, by the SUM server, location updates from each of the mobile devices, grouping, by the SUM server, first ones of the mobile devices into a first co-located group as a function of corresponding respective ones of the location updates, designating, by the SUM server, first sensor data from a first one of the first ones of the mobile devices in the first co-located group from at least one of the first ones of the mobile devices in the first co-located group as being colocation sensor data suitable for use by all of the first ones of the mobile devices in the first co-located group, designating, by the SUM server, second sensor data from a second one of the first ones of the mobile devices in the first co-located group as being sensor data suitable for use by all of the first ones of the mobile devices in the first co-located group, deriving, by the SUM server, first colocation sensor data from the first sensor data and the second sensor data, receiving, by the SUM server, requests for sensor data from the first ones of the mobile devices in the first co-located group, and in response to the receiving requests for sensor data, pushing, by the SUM server, the first colocation sensor data to the first ones of the mobile devices in the first co-located group making the requests.

In such an alternative exemplary embodiment, further features may include: receiving requests for sensor data includes receiving requests from mobile apps running on the first ones of the mobile devices in the first co-located group; generating, by the SUM server, group location management commands as a function of the location updates of the first ones of the mobile devices in the first co-located group, and pushing, by the SUM server, the group location management commands to the first ones of the mobile devices in the first co-located group; receiving, by the SUM server, first energy constraints from the first ones of the mobile devices in the first co-located group, and executing, by the SUM server, an energy model as a function of the first energy constraints; selecting, by the SUM server, a first group leader for the first co-located group as a function of the energy model; and grouping, by the SUM server, second ones of the mobile devices into a second co-location group as a function of corresponding respective ones of the location updates. Designating sensor data may include designating locational or non-locational data.

Such an alternative exemplary embodiment may include further features of: designating, by the SUM server, third sensor data from at least one of the first one of the second ones of the mobile devices in the second co-located group as being colocation sensor data suitable for use by all of the first second ones of the mobile devices in the second co-located group, designating, by the SUM server, fourth sensor data from a second one of the second ones of the mobile devices in the second co-located group as being sensor data suitable for use by all of the second ones of the mobile devices in the second co-located group, deriving, by the SUM server, second colocation sensor data from the third sensor data and the fourth sensor data, receiving, by the SUM server, requests for sensor data from the second ones of the mobile devices in the second co-located group, and in response to the receiving requests for sensor data, pushing, by the SUM server, the second colocation sensor data to the second ones of the mobile devices in the second co-located group making the requests.

In such an alternative exemplary embodiment, the first co-located group may have first-group locational data and the second co-located group may have second-group locational data. Grouping first ones of the mobile devices may include: receiving particular locational data from a particular one of the mobile devices; assigning the particular one of the mobile devices to the first co-located group if a difference between the particular locational data and the first-group locational data is less than a specified error tolerance; and assigning the particular one of the mobile devices to the second co-located group if a difference between the particular locational data and the second-group locational data is less than a specified error tolerance.

In a second alternative exemplary embodiment, a method of using a server to coordinate mobile device resources comprises receiving first locational data from a first mobile device at a first time, assigning the first mobile device to a first group, associating first group locational data with the first group, the first group locational data being derived at least partially from the first locational data, receiving second locational data from a second mobile device at a second time, assigning the second mobile device to the first group or a second group based on a comparison between the first time and the second time and a comparison between the first group locational data and the second locational data, updating the first group locational data based at least partially on the second locational data if the second mobile device is assigned to the first group, associating second group locational data with the second group if the second mobile device is assigned to the second group, the second group locational data being derived at least partially from the second locational data, receiving a location inquiry transmitted from the first mobile device at a third time, transmitting the first group locational data to the first mobile device if the second mobile device is associated with the first group and a difference between the second time and the third time is less than a first time threshold, transmitting the first group locational data to the first mobile device if the second mobile device is associated with the second group and a difference between the first time and the third time is less than a second time threshold, requesting updated locational data from the first mobile device if the second mobile device is associated with the first group and the difference between the second time and the third time is greater than the first time threshold, and requesting updated locational data from the first mobile device if the second mobile device is associated with the second group and the difference between the first time and the third time is greater than the second time threshold.

In such a second alternative exemplary embodiment, the comparison of the first group locational data and the second locational data may involve determining a difference between the first group locational data and the second locational data, and the comparison between the first time and the second time may involve determining a difference between the first time and the second time.

Such a second alternative exemplary embodiment may include further features of: assigning the second mobile device to the first group if the difference between the first group locational data and the second locational data is less than a specified error tolerance and the difference between the first time and the second time is less than a specified group timing threshold, and assigning the second mobile device to the second group if the difference between the first group locational data and the second locational data is greater than the specified error tolerance or the difference between the first time and the second time is greater than the specified group timing threshold; prompting a user of the second mobile device for the error tolerance; prompting a user of the second mobile device for the energy constraint. The error tolerance and energy constraint may be predetermined. The first time threshold may be shorter than the second time threshold. The first time threshold and second time threshold may be dependent upon an energy constraint.

In a third alternative exemplary embodiment, a method of managing sensor usage among one or more groups of mobile devices using a server, the method comprises: receiving, by the server, location updates from each of the mobile devices; grouping, by the server, first ones of the mobile devices into a first co-located group as a function of corresponding respective ones of the location updates; designating, by the server, sensor data from at least one of the first ones of the mobile devices in the first co-located group as being colocation sensor data suitable for use by all of the first ones of the mobile devices in the first co-located group; receiving, by the server, requests for sensor data from the first ones of the mobile devices in the first co-located group; and in response to said receiving requests for sensor data, pushing, by the server, the colocation sensor data to the first ones of the mobile devices in the first co-located group making the requests.

In such a third alternative exemplary embodiment: said receiving requests for sensor data can include receiving requests from mobile apps running on the first ones of the mobile devices in the first co-located group; said designating sensor data can include designating locational data. Such a third alternative exemplary embodiment may include further features of: generating, by the server, group location management commands as a function of the location updates of the first ones of the mobile devices in the first co-located group; and pushing, by the server, the group location management commands to the first ones of the mobile devices in the first co-located group; receiving, by the server, first energy constraints from the first ones of the mobile devices in the first co-located group; and executing, by the server, a crowdsourcing policy as a function of the first energy constraints; selecting, by the server, a first group leader for the first co-located group; grouping, by the server, second ones of the mobile devices into a second co-location group as a function of corresponding respective ones of the location updates; and designating, by the server, sensor data from at least one of the second ones of the mobile devices in the second co-located group as being colocation sensor data suitable for use by all of the second ones of the mobile devices in the second co-located group; receiving, by the server, requests for sensor data from the second ones of the mobile devices in the second co-located group; and in response to said receiving requests for sensor data, pushing, by the server, the colocation sensor data to the second ones of the mobile devices in the second co-located group making the requests. The first co-located group can have first-group locational data and the second co-located group can have second-group locational data, and said grouping first ones of the mobile devices can include: receiving particular locational data from a particular one of the mobile devices; assigning the particular one of the mobile devices to the first co-located group if a difference between the particular locational data and the first-group locational data is less than a specified error tolerance; and assigning the particular one of the mobile devices to the second co-located group if a difference between the particular locational data and the second-group locational data is less than a specified error tolerance.

In a fourth alternative exemplary embodiment, a method of generating measurements with mobile devices using a server comprises: selectively interfacing, by the server, with a first mobile device and a second mobile device; generating, by the server, a measurement indicative of a condition common to both said mobile devices; and transmitting, by the server, the measurement to at least one of the mobile devices. In such a fourth alternative exemplary embodiment, the measurement can include locational information and said server can be a centralized server. Such a third alternative exemplary embodiment may include further features of: operating the at least one of the mobile devices to exhibit the measurement or data derived at least partially from the measurement; generating, at the server, a plurality of measurements, which can include locational information, repeatedly and autonomously, each of the plurality of measurements being indicative of a condition common to both of said mobile devices; specifying an energy constraint on at least one of the mobile devices or the server; and generating a measurement indicative of a condition of the at least one of the mobile devices through the use of a sensor in the at least one of the mobile devices, the measurement having an accuracy dependent upon the energy constraint; generating, at the server, a plurality of measurements repeatedly and autonomously, each of the plurality of measurements being indicative of a condition of the at least one of the mobile devices and having an accuracy dependent upon the energy constraint.

In a fifth alternative exemplary embodiment, a method of generating measurements with mobile devices using a server comprises: receiving, at the server, a first measurement indicative of a condition of a first mobile device generated through the use of a sensor in the first mobile device; receiving, at the server, a second measurement indicative of a condition of a second mobile device generated through the use of a sensor in the second mobile device; analyzing, by the server, the first and second measurements; and determining, by the server, whether the first and the second mobile devices should be treated as a group based on the analysis of the first and second measurements; and if the determination of whether the first and second mobile devices should be treated as a group is positive: defining a first group comprising the first mobile device and second mobile device; receiving, at the server, a third measurement indicative of a condition of the first mobile device generated through the use of the sensor in the first mobile device; and transmitting, by the server, said third measurement or data derived at least partially from said third measurement to the second mobile device. Such a fifth alternative exemplary embodiment may include further features of: exhibiting said third measurement or data derived at least partially from said third measurement on the second mobile device.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. A method of generating measurements with mobile devices using a server, the method comprising:
selectively interfacing, by the server, with a first mobile device and a second mobile device;
generating, by the server, a measurement indicative of a condition common to both said mobile devices; and
transmitting, by the server, the measurement to at least one of the mobile devices.
